(19) United States
(12) Patent Application Publication
(10) Pub. No.: US 2007/0261683 A1
(43) Pub. Date: Nov. 15, 2007

(54) Vehicle having an exhaust gas recirculation system

(75) Inventors: Gerhard Weiss, Gleink (AT); Wilfried Barth, Arbing (AT); Gernot Tschaler, St. Valentin (AT); Karl Mayr, Behamberg (AT); Andreas Nabecker, St. Georgen (AT)

Correspondence Address: CROWELL & MORING LLP;INTELLECTUAL PROPERTY GROUP, P.O. BOX 14300, WASHINGTON, DC, 20044-4300, US

(73) Assignee: Bayerische Motoren Werke Aktiengesellschaft, Muenchen (DE)

(21) Appl. No.: 11/826,661

(22) Filed: Jul. 17, 2007

Related U.S. Application Data
(63) Continuation of application No. PCT/EP05/12412, filed on Nov. 19, 2005.

(30) Foreign Application Priority Data
Jan. 18, 2005 (DE) 10 2005 002 266.9
Mar. 3, 2005 (DE) 10 2005 009 638.7

(51) Int. Cl. F02M 25/07; F02B 33/44; F02B 47/08

(52) U.S. Cl. 123/568.17; 123/568.24; 60/605.2

(57) ABSTRACT

A vehicle with an engine, especially a diesel engine, is provided and includes: an intake tract, via which air is supplied to the engine, an exhaust gas tract, via which exhaust gas emitted by the diesel engine is discharged towards an exhaust gas tailpipe and through the exhaust gas tailpipe to the environment, a branch-off valve, disposed in the exhaust gas tract and having an inlet, a first outlet, connected to the exhaust gas tailpipe, and a second outlet, connected to the intake tract. The branch-off valve has a first and second flap that are kinematically interconnected. The first flap is provided for at least partially closing the first outlet and the second flap is provided for at least partially closing the second outlet.

### CROSS-REFERENCE TO RELATED APPLICATIONS

This application is a continuation of PCT International Application No. PCT/EP2005/012412, filed on Nov. 19, 2005, which claims priority under 35 U.S.C. § 119 to German Application Nos. 10 2005 002 266.9, filed Jan. 18, 2005 and 10 2005 009 638.7, filed Mar. 3, 2005, the entire disclosures of which are expressly incorporated by reference herein.

### BACKGROUND AND SUMMARY OF THE INVENTION

The present invention relates to a vehicle with an engine, particularly a diesel engine, having an intake tract by way of which air is supplied to the engine, and an exhaust gas tract by way of which exhaust gas flowing out of the diesel engine can be discharged toward an exhaust gas tailpipe and through the exhaust gas tailpipe into the environment.

The state of the art is represented by diesel engine vehicles, which are equipped with an exhaust gas turbocharger, a charge air cooler and an exhaust gas recirculation device. Conventionally, a “branch-off valve” is arranged in the exhaust gas tract, which branch-off valve has a first output leading to the exhaust gas tailpipe as well as a second output which is connected with the intake tract of the engine. By way of the second output, exhaust gas can be admixed to the air taken into the intake tract.

It is an object of the invention to provide a vehicle whose exhaust gas recirculation device is equipped with an improved branch-off valve.

The invention is based on a vehicle with an engine, particularly a diesel engine, having an intake tract, an exhaust gas tract and a branch-off valve. The engine is supplied with air by way of the intake tract. By way of the exhaust gas tract, the exhaust gas generated by the engine is discharged in the direction of an exhaust gas tailpipe into the environment. The branch-off valve is arranged in the exhaust gas tract. This valve has an engine-side input as well as a first and a second output. The first output of the branch-off valve leads to the exhaust gas tailpipe. Thus, the partial exhaust gas volume flow that is to be discharged into the environment flows through the first output. The second output of the branch-off valve is connected with the intake tract. By way of the second output, a partial exhaust gas volume flow can be guided into the intake tract of the engine.

The invention consists of the fact that the branch-off valve has two kinematically mutually coupled flaps. It can, therefore, also be called a branch-off valve having a “double flap”. The first flap is assigned to the first output, and the second flap is assigned to the second output and/or to the first output. In this context, the term “and/or” means the following. It may be provided that the first output can be completely closed by the first flap, and that the second output can be completely closed by the second flap. As an alternative, it may be provided that only a partial cross-section of the first output is covered by the first flap, and thus only this partial cross-section can be closed by the first flap, and that another partial cross-section or the remaining partial cross-section, which cannot be closed by the first flap, can be closed by the second flap. In this case, by means of the second flap, depending on the flap position, a partial cross-section of the first output or the entire second output can be closed.

The two flaps are arranged between the engine-side input and the respective output of the branch-off valve. The term “kinematically coupled” can be broadly interpreted and generally means that the two flaps can be moved simultaneously. The two flaps can be mechanically coupled, for example, by way of a linkage mechanism, a gear mechanism, a belt drive, a chain drive, or the like. However, the two flaps do not necessarily have to be mutually mechanically coupled. They may also, in each case, be provided with separate “actuators”, such as an electric or servo drive, a hydraulic drive, a pneumatic drive, or the like, respectively.

The two flaps are preferably mutually coupled in kinematically opposed directions. In this context, “in opposed directions” means that, when the first flap is opened, the second flap is closed and vice versa.

Advantageous embodiments and further developments of the invention are described herein.

According to a further development of the invention, the engine is equipped with an exhaust gas turbocharger. It is known that the exhaust gas turbocharger has a compressor and a turbine. The compressor is arranged in the intake tract of the engine. Furthermore, a charge air cooler may be arranged between the compressor and the engine. By way of a shaft, the compressor is coupled with the turbine of the exhaust gas turbocharger, which turbine is arranged in the exhaust gas tract of the engine. Additionally, a carbon particle filter may be arranged in the area between the turbine and the exhaust gas tailpipe; that is, viewed in the flow direction, behind the turbine.

Viewed in the flow direction of the exhaust gas, the branch-off valve is preferably arranged behind the carbon particle filter. The exhaust gas fed to the intake tract is therefore free or almost free of carbon particles, which has the advantage that the recirculated exhaust gas does not pollute the intake tract. It is another advantage that the entire exhaust gas volume flow flows through the turbine of the exhaust gas turbocharger, so that the entire kinetic energy of the exhaust gas can be optimally utilized.

Viewed in the flow direction, the exhaust gas branched off by way of the branch-off valve can be fed to the intake tract in front of the compressor. As an alternative, the recirculated exhaust gas can also be fed to the intake tract in a direct manner by way of the compressor housing. The flaps of the branch-off valve each have a starting position in which the entire exhaust gas emitted by the engine is guided to the exhaust gas tailpipe, and the connection toward the intake tract is shut off. By means of the “opening” of the branch-off valve, the fluid connection to the intake tract is opened more and more, and simultaneously the first output, that is, the fluid connection leading to the exhaust gas tailpipe, is closed more and more. In this case, the second flap is used as a control flap for the exhaust gas recirculation duct connecting the branch-off valve with the intake tract and, when opened further, as a throttle valve for the exhaust gas flow flowing in the direction of the exhaust gas tailpipe. The first flap closes the first output of the branch-off valve in the direction opposite to that of the second flap.

According to a further development of the invention, a cooler, which cools the recirculated exhaust gas, is arranged between the “removal point” in the exhaust gas tract and the intake tract, that is, in the area between the carbon particle filter and the intake tract.

The branch-off valve and the fluid pipe for the recirculation of exhaust gas from the exhaust gas tract into the intake tract as well as the cooler for cooling the recirculated exhaust gas may be arranged directly at the carbon particle filter. The exhaust gas manifold of the engine, the exhaust gas turbocharger, the carbon particle filter and the branch-off valve preferably form a pre-assembled constructional unit.

Other objects, advantages and novel features of the present invention will become apparent from the following detailed description of the invention when considered in conjunction with the accompanying drawings.

### BRIEF DESCRIPTION OF THE DRAWINGS

FIG. 1 is a schematic representation for explaining a first embodiment according to the invention;

FIG. 2 is a schematic representation for explaining a second embodiment according to the invention; and

FIGS. 3 to 6 are views of the branch-off valve in different operating positions.

### DETAILED DESCRIPTION OF THE DRAWINGS

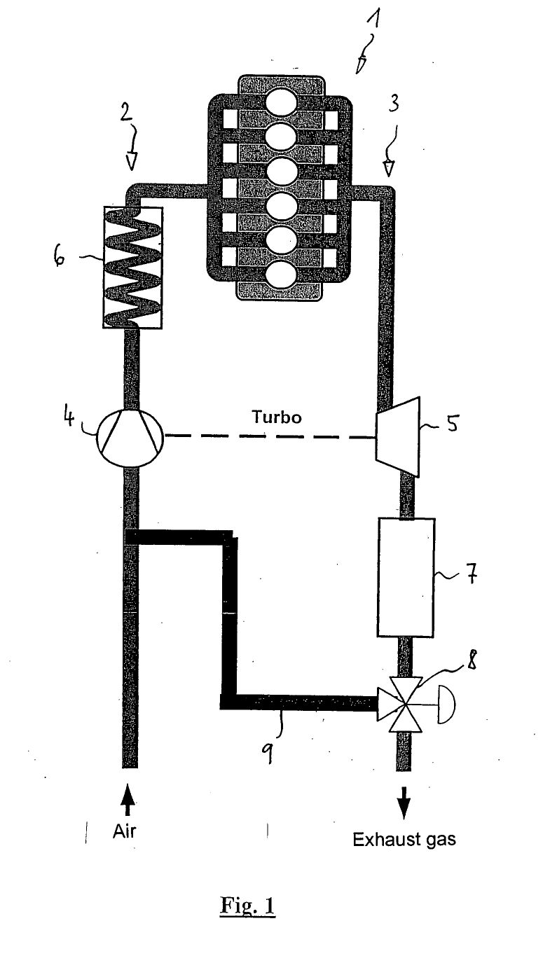

FIG. 1 is a schematic view of a turbo diesel engine 1 having an intake tract 2 and an exhaust gas tract 3. A compressor 4 is arranged in the intake tract 2 and is rotationally coupled with a turbine 5, which is arranged in the exhaust gas tract 3. The compressor 4 and the turbine 5 form an exhaust gas turbocharger. The exhaust gas of the diesel engine 1 flows through the turbine 5 and drives the compressor 4. By way of an air filter, which is not shown here in detail, the compressor 4 takes in fresh air, compresses it and guides the compressed fresh air by way of a charge air cooler 6, in which the compressed fresh air is cooled, to the diesel engine 1.

In the exhaust gas tract 3, a carbon particle filter 7 is arranged behind the turbine 5 and filters out a large portion of the carbon particles contained in the exhaust gas. Viewed in the flow direction of the exhaust gas, a branch-off valve 8 is arranged downstream of the carbon particle filter. The branch-off valve 8 has a starting position in which the entire exhaust gas volume flow flows by way of an exhaust gas tailpipe (not shown here in detail) from the exhaust gas tract into the environment. By way of a connection pipe 9, the branch-off valve 8 is connected with the intake tract 2. In the embodiment illustrated here, the connection pipe 9 leads in the intake direction in front of (upstream of) the compressor 4 into the intake tract.

With an increasing “opening” of the branch-off valve 8, the flow path to the connection pipe 9 is increasingly opened and the flow cross-section toward the exhaust gas tailpipe is increasingly closed. The branch-off valve 8 is preferably an electronically controllable valve whose valve position is controlled as a function of various engine and operating condition parameters. Since the recirculated exhaust gas is taken from the exhaust gas tract 3 downstream of the carbon particle filter 7, it can be fed without any problem to the intake tract 2 in front of the compressor 4 and the charge air cooler 6.

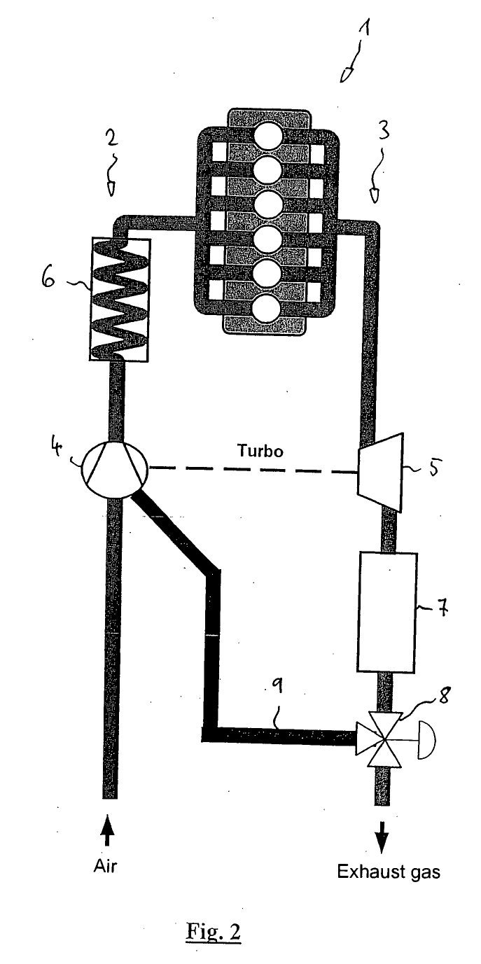

FIG. 2 shows a variant of the embodiment of FIG. 1. In contrast to the embodiment of FIG. 1, here the branch-off valve 8 is connected by way of the connection pipe 9 directly with the compressor 4. The exhaust gas to be recirculated is therefore introduced into the compressor 4 directly by way of the compressor housing (not shown).

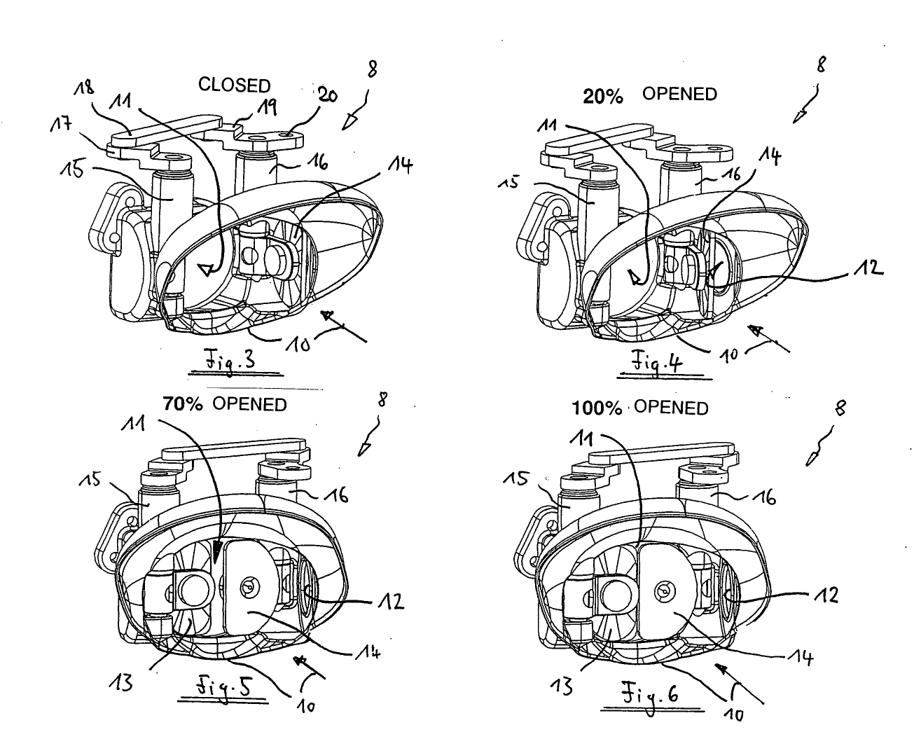

FIGS. 3 to 6 show detailed explanations of the construction and method of operation of the branch-off valve 8. The branch-off valve 8 has an “engine-side” fluid input 10, as well as a first and second output 11, 12. The arrow, marked with the reference number 10, indicates the flow direction in which the exhaust gas coming from he engine or the carbon particle filter 7 flows into the branch-off valve 8. The first output 11 leads to the exhaust gas tailpipe (not shown). By way of the first output 11, the exhaust gas therefore flows into the environment. The connection pipe 9 (compare FIGS. 1, 2) is connected to the second output 12 of the branch-off valve 8. By way of the second output 12, exhaust gas can therefore be guided to the intake tract 2 (compare FIGS. 1, 2).

As best illustrated in FIGS. 5 and 6, the branch-off valve 8 has a first flap 13 and a second flap 14. The first flap 13 is not visible in the flap position illustrated in FIGS. 3 and 4.

The two flaps 13, 14 are each swivellably arranged about a swivel pin. The first flap 13 can be swiveled about a first swivel pin 15. The second flap 14 can be swiveled about a second swivel pin 16. The two flaps 13, 14, or their swivel pins 15, 16, are mutually mechanically coupled by way of a lever mechanism 17-19 (see FIG. 3). During the swiveling of one flap, the other flap is swiveled along, and vice-versa. For actuating the flaps, an actuator may be provided (which is not shown here in detail) and is applied, for example, to an eye 20 of the lever 19.

In the position illustrated in FIG. 3, the second output 12 is completely closed by the second flap 14. In contrast, the first output 11 is completely open. Thus, the entire exhaust gas volume flow flows through the first output 11 to the exhaust gas tailpipe (not shown).

FIG. 4 shows an operating position in which the second output 12 is slightly open. In this case, the second flap 14 is opened by approximately 20°. In contrast, the first flap visible in FIG. 4 is correspondingly slightly swiveled to its closed position. Although a small partial volume flow of the exhaust gas will flow by way of the second output 12 to the intake tract, the predominant portion of the exhaust gas flows through the first output 12 into the environment.

FIG. 5 shows an operating position in which the second output 12 is almost completely open. In comparison to FIG. 3, the second flap 14 is swiveled by approximately 70° to the open position. The first flap 13 is swiveled only by approximately 70°. In this position, only a comparatively small partial volume flow of the exhaust gas still flows by way of the first output 11 to the exhaust gas tailpipe. The predominant portion of the exhaust gas flows to the intake tract by way of the second output 12.

FIG. 6 shows a flap position in which the second output 12 is completely open and the first output 11 is virtually completely closed by the two flaps 13, 14. As a result, the greater part of the exhaust gas flows to the intake tract by way of the second output 12.

In the embodiment illustrated in FIGS. 3 and 6, the first output 11 is closed by two flaps 13, 14. As an alternative, it may also be provided that flap 13 has a correspondingly larger design and the first output 11 is closed only by flap 13.

It is also a characteristic of the embodiment illustrated in FIGS. 3 to 6 that, during a movement of the flaps 13, 14, their angular velocity vectors are oriented in mutually opposite directions. As best illustrated in FIGS. 5 and 6, for example, the flap 13 swivels out of the plane of projection, and the flap 14 swivels toward the plane of projection, or vice versa. As a result of the restricted mechanical coupling of the two flaps 13, 14, the flow forces applied to the flaps 13, 14 therefore completely or at least partially cancel one another. An adjustment of the flaps by operating the lever 19 therefore requires only relatively low operating forces.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A vehicle having an engine, comprising:
an intake tract by way of which air is supplied to the engine;
an exhaust gas tract by way of which exhaust gas flowing out of the engine is dischargeable toward an exhaust gas tailpipe;
a branch-off valve arranged in the exhaust gas tract, the branch-off valve having an input, a first output coupled with the exhaust gas tailpipe, a second output coupled with the intake tract, and first and second flaps; and
wherein the first and second flaps are mutually coupled kinematically, the first flap being operatively configured for at least partial closing of the first output and the second flap being operatively configured for at least partial closing of the second output.

2. The vehicle according to claim 1, wherein the second flap is further operatively configured for complete closing of the second output and for partial closing of the first output.

3. The vehicle according to claim 1, wherein the first and second flaps have a respective flap position, in which the first and second flaps together close the first output, the first flap closing a first partial cross-section and the second flap closing a second partial cross-section of the first output.

4. The vehicle according to claim 2, wherein the first and second flaps have a respective flap position, in which the first and second flaps together close the first output, the first flap closing a first partial cross-section and the second flap closing a second partial cross-section of the first output.

5. The vehicle according to claim 1, wherein the two flaps are mutually coupled mechanically.

6. The vehicle according to claim 1, wherein the two flaps are mutually coupled in opposite directions such that, during a rotation of the first flap in a first direction, the second flap is rotated in an opposite direction, and vice-versa.

7. The vehicle according to claim 6, wherein the two flaps are mutually coupled by a toothed gearing.

8. The vehicle according to claim 5, wherein the two flaps are mutually coupled by a lever mechanism.

9. The vehicle according to claim 1, further comprising:
a compressor of an exhaust gas turbocharger;
a charge air cooler; and
wherein the compressor is arranged in the intake tract, and an output of the compressor is coupled with the engine by way of the charge air cooler.

10. The vehicle according to claim 9, further comprising a turbine of the exhaust gas turbocharger, the turbine being rotationally coupled with the compressor and being arranged in the exhaust gas tract.

11. The vehicle according to claim 10, further comprising a carbon particle filter arranged in a flow direction between the turbine and the exhaust gas tailpipe.

12. The vehicle according to claim 11, wherein the branch-off valve is arranged in the flow direction between the carbon particle filter and the exhaust gas tailpipe.

13. The vehicle according to claim 1, wherein, in a flow direction of air taken in by the intake tract, the branch-off valve is coupled to the intake tract upstream of the compressor.

14. The vehicle according to claim 1, further comprising a connection pipe by which the branch-off valve is in a direct fluid connection with the compressor.

15. The vehicle according to claim 11, further comprising an exhaust gas manifold flanged to the engine, wherein the exhaust gas manifold, together with the exhaust gas turbo charger, the carbon particle filter, and the branch-off valve are mutually connected to form a constructional unit.

16. The vehicle according to claim 1, wherein the engine is a diesel engine.

17. The vehicle according to claim 2, wherein the two flaps are mutually coupled mechanically.

18. The vehicle according to claim 3, wherein the two flaps are mutually coupled mechanically.

19. The vehicle according to claim 4, wherein the two flaps are mutually coupled mechanically.

20. The vehicle according to claim 2, wherein the two flaps are mutually coupled in opposite directions such that, during a rotation of the first flap in a first direction, the second flap is rotated in an opposite direction, and vice-versa.
